(19) United States
(12) Patent Application Publication
(10) Pub. No.: US 2018/0115026 A1
(43) Pub. Date: Apr. 26, 2018

(54) FLEXIBLE IMPREGNATED BATTERY ARRAY

(71) Applicant: Brandon William Mairs, Berkely, CA (US)

(72) Inventor: Brandon William Mairs, Berkely, CA (US)

(73) Assignee: Arubixs, Inc., Berkeley, CA (US)

(21) Appl. No.: 15/334,252

(22) Filed: Oct. 25, 2016

(51) Int. Cl. H01M 10/46; H01M 10/42; H01M 2/20; H01M 2/10; H02J 7/02; H02J 50/20

(52) U.S. Cl. CPC H01M 10/46; H01M 10/425; H01M 2/202; H01M 10/0525; H01M 2/1094; H02J 7/025; H02J 50/20; H01M 2/1022

(57) ABSTRACT

A quad dimensionally flexible battery device. The preferred embodiment of the invention is an array of battery cells connected to a plurality of terminal connectors, at least one power control module, and at least one wireless charging coil, all of which are impregnated in a rubber composite material except for the negative an positive terminal ends.

### CROSS REFERENCE TO RELATED APPLICATIONS

This application claims the benefit of U.S. Provisional Patent Application No. 62/246,585 filed Oct. 26, 2015, entitled “Flexible Impregnated Battery Array”, the disclosure of which is incorporated by reference herein in its entirety.

### FIELD OF THE INVENTION

The present invention discloses a flexible battery array which is flexible in at least four directions (herein referred to as “four dimensions”). The preferred embodiment of the invention comprises a plurality of flexible terminal connectors attached to each battery cell in the array, thereby connecting the battery cells in parallel and each connected to a wireless charging coil, and all of which are impregnated in a flexible and a charging coil and power management.

### BACKGROUND OF THE INVENTION

Current batteries are generally not flexible by design. Although current batteries may be forcibly flexed, there is not a solution for power system that can take extended flexing in four opposing directions. Current solutions can only flex in two opposing directions When batteries are physically flexible, repeated flexing of the battery quickly leads to material fatigue, loss of capacity, and ultimately battery failure or a very short lifecycle. This is very apparent in the use of batteries in mobile devices, where impact damage to devices, including damage to battery, screen glass and power control module, is a consistent concern and problem. In fact, current mobile devices frequently sustain damage no matter how durable the device housing and glass screen are made. In addition, most mobile devices are not waterproof or even water resistant. The need for a flexible and a waterproof mobile device is apparent in the flourishing industry of protective cases for mobile devices.

Current mobile device batteries are not flexible by design because nearly every mobile device, if not every mobile device, uses lithium-ion batteries due to their efficiency and energy storage considerations. However, as is commonly known in the art, lithium batteries function best in condensed configurations, inevitably resulting in relatively large, often “blocky” or cylindrical configurations. Current mobile device batteries are solid based, non-flexible, relatively large-sized batteries that take up a lot of space in the phone. The space the battery takes up affects the remainder of the hardware and power control module space of the device.

What is needed is a flexible battery for mobile devices that is both flexible in at least four directions with a charging coil and power control module on each battery cell. A flexible battery that is also contained in a waterproof housing is likewise needed. What is further needed is a battery in a slimmer design to allow various configurations within mobile device.

### SUMMARY OF THE INVENTION

Disclosed is a flexible battery array.

It is an object of the preferred embodiment to overcome the limitations inherent in in the various rigid and bi-flexible batteries referenced above, with a quad-flexible battery.

Yet another embodiment discloses a flexible battery array that is waterproof.

Still another preferred embodiment discloses a battery array flexible in at least four directions that includes a plurality of wireless charging coils.

The preferred embodiment of the present invention relates to the use of an array of battery cells, connected with at least one flexible terminal connector and a power control module, all of which are impregnated in a rubber composite housing except for the positive and negative terminals.

### BRIEF DESCRIPTION OF DRAWINGS

FIG. 1 illustrates an example of the battery array connected by a single terminal connector.

FIG. 2 illustrates an example of the battery array connected by two terminal connectors with a power control module impregnated in a rubber composite housing,

FIG. 3 illustrates a side view of the battery array connected by two terminal connectors impregnated in a rubber composite housing.

FIG. 4 illustrates an example of the battery array connected by two terminal connectors with a power control module impregnated in a rubber composite housing

FIG. 5 illustrates a side view of the battery array connected by two terminal connectors impregnated in a rubber composite housing.

FIG. 6 illustrates a detailed view of one battery cell of the battery array.

FIG. 7 illustrates an embodiment with hexagon-shaped individual battery cells.

FIG. 8 illustrates another embodiment with hexagon-shaped individual battery cells.

FIG. 9 illustrates an embodiment with octagon-shaped individual battery cells.

### DETAILED DESCRIPTION OF PREFERRED EMBODIMENTS OF THE INVENTION

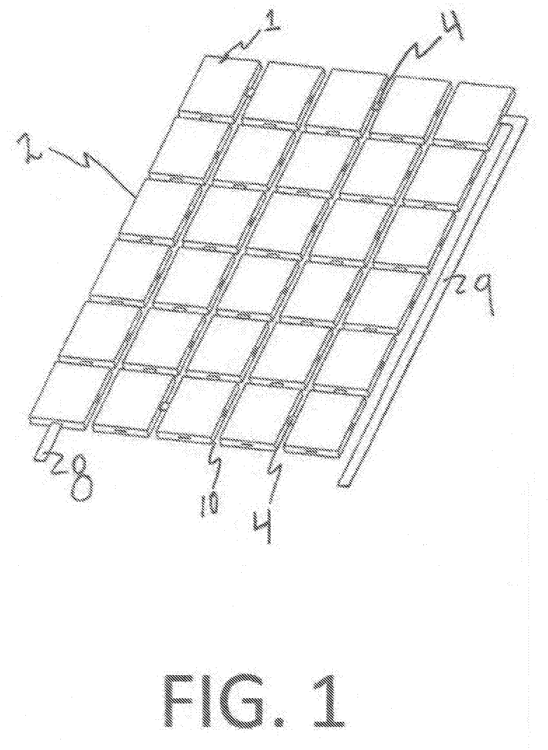

FIG. 1. illustrates an embodiment of the quad flexible battery array wherein the thin individual battery cells (1) are arranged in a grid to form a battery array (2). The individual battery cells may be in the shape of a quadrilateral. The battery cells in the array are all used together to produce the required energy.

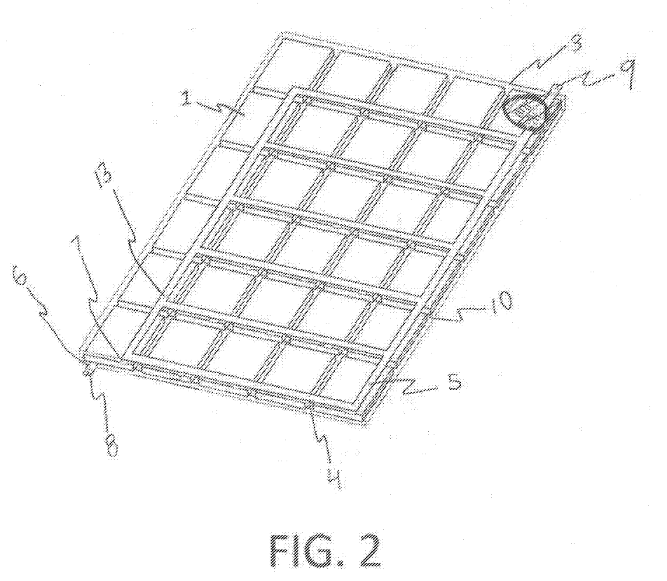

FIG. 2 illustrates the battery cell grid held in place with a flexible material (3). In one embodiment, this flexible material is rubber. In a second embodiment, this flexible material is a rubber and an aramid fiber material, such as Kevlar®. In the preferred embodiment, the flexible material (3) is impregnated with the battery cells.

The battery cell terminals are connected with a flexible terminal connector (4). The terminal connectors can include materials such as foil, wire and composite cloth. In one embodiment, the terminal connector is comprised of a single perforated grid (5) attached to each cell (1). In the preferred embodiment, the terminal connector is comprised of a plurality of terminal grids (5) attached to each cell. Furthermore, in the preferred embodiment, the individual battery cell negative terminal (6) is folded to one side of the battery cell and welded to the negative terminal connector (14) and the battery cell positive terminal is (7) is folded to the opposite side of the negative terminal and welded to the positive terminal connector (13).

The attachment of the terminal connector (4) to each cell (1) creates less electrical surface area and thereby reduces wasted current. Moreover, the amount of wire connections which would otherwise be required is reduced.

The battery cell array contains space (10) between each cell allowing flexing of the whole structure in two different axis. The space (10) between each cell also aids in heat dissipation of the each cell. In a preferred embodiment, the space between each battery cell is both vertical and horizontal, but other embodiments also include further space orientations, as described herein.

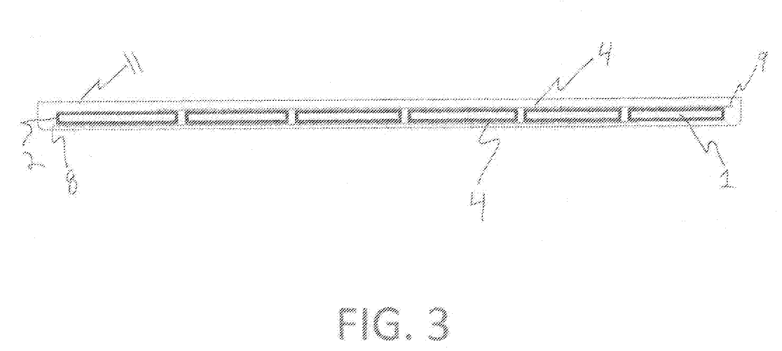

Referring now to FIG. 2 and FIG. 3, the terminal of the positive current side (9) which is on the opposite side of the battery cell array, and therefore inversely positioned, from the terminal of the negative current side (8). The positive terminal and the negative terminal are inversely positioned from each other for charging and discharging throughout the battery cell array architecture.

In the preferred embodiment, the flexible terminal connectors are comprised of composite fabric, which may include carbon fiber, aluminum coated fiberglass, copper coated onto fiberglass, aluminum coated aramid fiber (such as Kevlar®) or copper coated aramid fiber (such as Kevlar®). In this preferred embodiment, the perforate exterior packing terminal connectors connect the battery cells in parallel.

In the preferred embodiment, the terminal connector (4) and battery cells (1) are impregnated into a flexible material (4), securing all of the pieces and allowing flexibility. In a preferred embodiment for mobile devices, the flexible material (11) is impregnated with the battery cell array (2) and comprises the housing of the mobile device.

In the preferred embodiment, the cellular batteries connected to in a layer the aramid fiber (such as Kevlar®) infused rubber. The rubber composite housing completely encloses the battery array except for the negative terminal and the positive terminal.

An embodiment contains a power control module (“pcm”) (12) to control the amount of charge placed into the battery cells. In the preferred embodiment, the pcm (12) is also enclosed within the rubber composite housing. (11)

In the case of the preferred embodiment being used in a mobile device, the case of the mobile device with the battery cell array (2), terminal connector grids (4) and the pcm (12) are impregnated in the aramid fiber (such as Kevlar®) infused rubber which comprises at least a portion of the mobile device exterior housing.

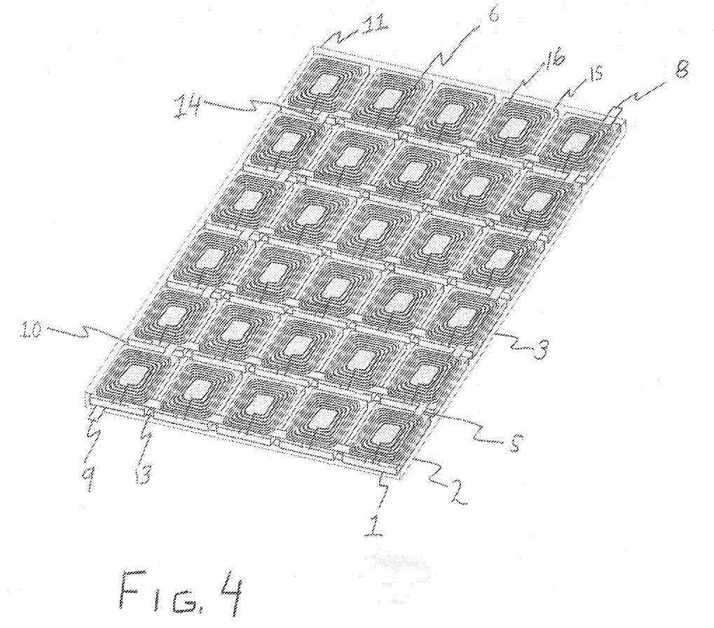

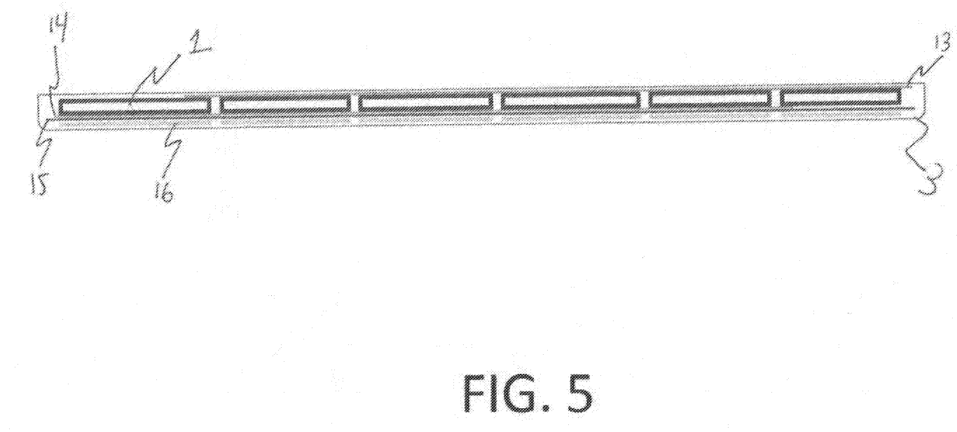

Referring now to FIG. 4 and FIG. 5, in the preferred embodiment, the battery cell terminals of the battery array are connected with one positive flexible terminal connector (13) and one negative flexible terminal connector (14) and, in addition to the features described in FIG. 2 and FIG. 3, each battery cell and terminal connector assembly also is connected to a conductive RF shielding film (15). The conductive RF shielding film (15) is used to shield the battery cell from the wireless charging coil (16) on each cell and connected thereto for wireless charging of each battery cell.

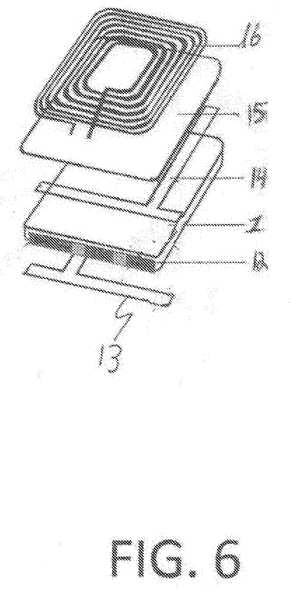

Referring now to FIG. 6, an embodiment has a pcm (12) on each battery cell (1). The positive flexible terminal connector (13), and the negative terminal connector (14), the conductive RF shielding film (15), and the wireless charging coil (16) are shown. Each battery cell (1) connected to a power control module (12) and each power control module (12) connected to a wireless charging coil (16).

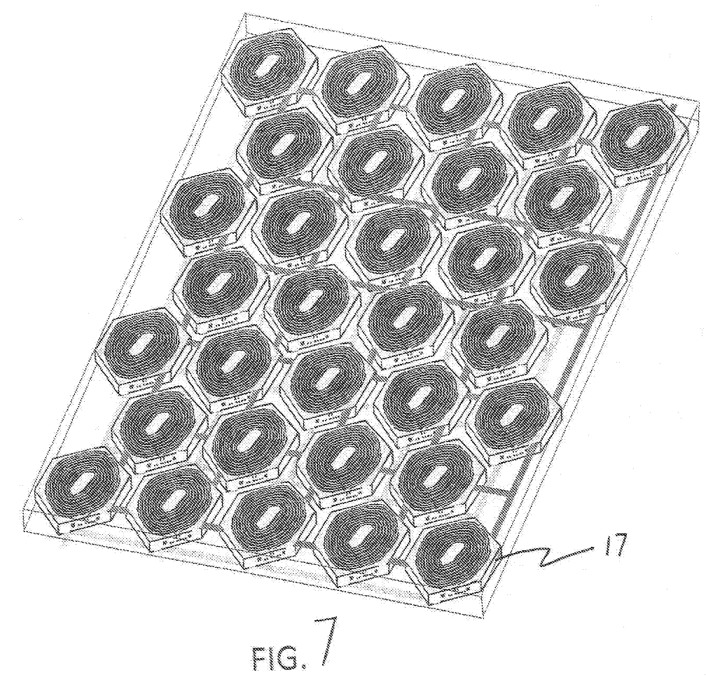

Referring now to FIG. 7, an embodiment has hexagon-shaped individual battery cells (17).

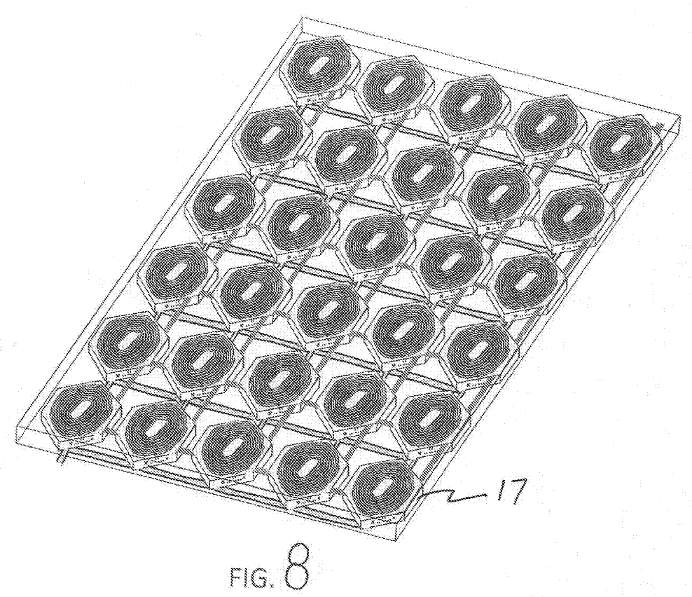

Referring now to FIG. 8, another embodiment has hexagon-shaped individual battery cells (17).

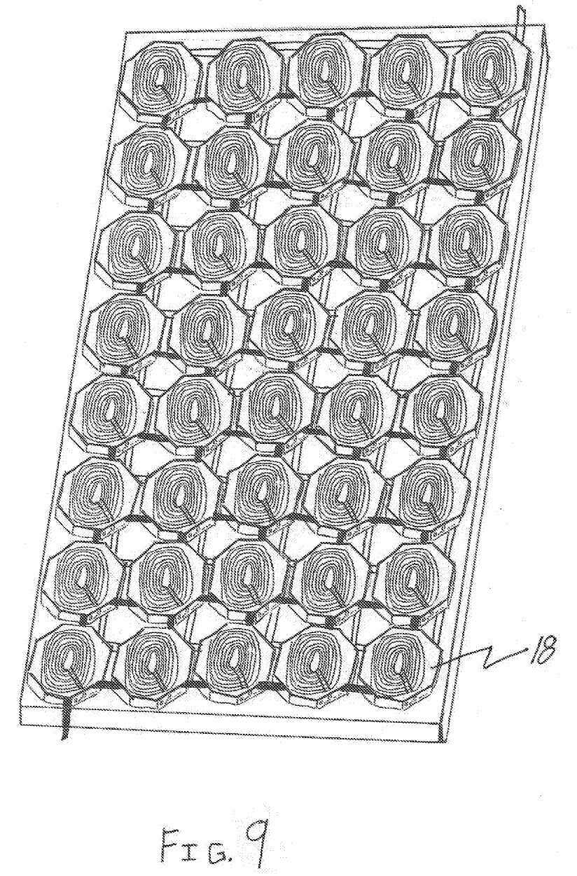

Referring now to FIG. 9, yet another embodiment has octagon-shaped individual battery cells (18).

Upon reading this disclosure, those of skill in the art will appreciate still additional alternative structural and function designs for a quad dimensionally flexible battery.

For example, shapes and orientations of the individual battery cells are not limited to squares, circles, cubes, hexagons, octagons or any other shape. Thus, while particular embodiments and applications have been illustrated and described, it is to be understood that the disclosed embodiments are not limited to the precise construction and components disclosed herein. Thus, while particular embodiments and applications have been illustrated and described, it is to be understood that the disclosed embodiments are not limited to the precise construction and components disclosed herein. Additionally, variants of additional embodiments are possible. Therefore, the spirit and scope of the appended claims and the concepts taught herein should not be limited to the description of the preferred embodiments and embodiments contained herein.

1. A flexible battery device, comprising:
A plurality of battery cells in an array, each said battery cell having at least two opposing sides and a negative terminal and a positive terminal, and each said battery cell connected to a power control module and each said power control module connected to a wireless charging coil, and said battery cell array having a negative terminal and a positive terminal, and said battery cell array having a top surface and a bottom surface;
A flexible positive terminal connector perforated grid connecting each battery cell positive terminal in the battery cell array and a negative terminal connector perforated grid connecting each battery cell negative terminal in the battery cell array;
A flexible exterior housing with said battery array and said terminal connectors impregnated in said flexible exterior housing.

2. The device of claim 1 wherein said positive terminal connector and said negative terminal connector extend beyond said flexible exterior housing.

3. The device of claim 1 wherein each said battery cell shape is selected from the group consisting of quadrilateral, hexagon and octagon.

4. The device of claim 1 wherein said flexible exterior housing comprises a portion of a mobile device.

5. The device of claim 1 further comprising a conductive RF shield between said wireless charging coil and said battery cell.

6. The device of claim 1 wherein said flexible exterior housing is made of an aramid fiber infused rubber.

7. The device of claim 4 wherein said flexible exterior housing is made of an aramid fiber infused rubber.

8. The device of claim 1 wherein said flexible terminal connector is comprised of material selected from the group consisting of carbon fiber, aluminum coated fiberglass, copper coated onto fiberglass, aluminum coated aramid fiber and copper coated aramid fiber.

9. A flexible battery device, comprising:
A plurality of battery cells in an array, each said battery cell having at least two opposing sides and a negative terminal and a positive terminal, and each said battery cell connected to a power control module and each said power control module connected to a wireless charging coil, and said battery cell array having a negative terminal and a positive terminal, and said array having a top surface and a bottom surface;
A flexible positive terminal connector perforated grid connecting each battery cell positive terminal in the battery cell array and a negative terminal connector perforated grid connecting each battery cell negative terminal in the battery cell array;
A conductive RF shield between each said wireless charging coil and each said battery cell;
A flexible exterior housing comprised of aramid fiber infused rubber with said battery array and said terminal connectors impregnated in said flexible exterior housing.

10. The device of claim 9 wherein each said battery cell shape is selected from the group consisting of quadrilateral, hexagon and octagon.

11. The device of claim 9 wherein said flexible terminal connector is comprised of material selected from the group consisting of carbon fiber, aluminum coated fiberglass, copper coated onto fiberglass, aluminum coated aramid fiber and copper coated aramid fiber.

12. The device of claim 9 wherein said flexible exterior housing comprises a portion of a mobile device.
